(19) United States
(12) Patent Application Publication
(10) Pub. No.: US 2011/0014857 A1
(43) Pub. Date: Jan. 20, 2011

(54) HAND-HELD MACHINE TOOL, IN PARTICULAR HAND-GUIDED GRINDING MACHINE

(76) Inventors: Balazs Bogardi, Szent Istvan (HU); Roland Kaplar, Miskolc-Pereces (HU)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/933,253

(22) PCT Filed: Nov. 18, 2008
(86) PCT No.: PCT/EP2008/065708

§ 371 Date: Sep. 17, 2010

(30) Foreign Application Priority Data
Mar. 18, 2008 (DE) 102008000728.5

(51) Int. Cl. B25F 5/02; B24B 23/00

(52) U.S. Cl. 451/344

(57) ABSTRACT

A hand-held machine tool is provided with a split housing, the two parts of which are to be connected via a connecting device that is designed as a plug-in connection. The connecting device has a receiving groove on one housing part and a projection on the other housing part.

The invention relates to a hand-held power tool, in particular a hand-guided grinding machine such as an angle grinder.

### PRIOR ART

EP 0 583 270 B1 has disclosed an angle grinder that has a housing accommodating a drive motor for rotatably driving a shaft that accommodates a tool. During operation, the housing of the hand-held power tool is subjected to mechanical stresses caused by oscillations of the drive motor and tool and by the contact between the tool and the work piece being machined. The stresses acting on the housing here must not be permitted to result in failure during the service life of the hand-held power tool.

In addition to meeting stability requirements, the hand-held power tool and its housing must also be easy and trouble-free to assemble.

### DISCLOSURE OF THE INVENTION

The object of the invention is to simplify the assembly of a hand-held power tool and at the same time, to ensure a high degree of stability, particular in the housing of the hand-held power tool.

This object is attained according to the invention with the defining characteristics of claim 1. The dependent claims disclose suitable modifications.

The hand-held power tool according to the invention, in particular a hand-guided grinding machine such as an angle grinder, has an at least two-part housing whose two housing parts are to be connected to each other by means of a connecting device. The connecting device is embodied in the form of a plugged connection, which on one housing part, has a receiving groove and on the other housing part, has a projection that engages in the receiving groove. The groove walls that delimit the receiving groove here extend in the assembly direction of the housing parts, i.e. in the direction in which the projection is inserted into the receiving groove.

This embodiment is characterized by a high degree of stability since the groove walls stabilize the two housing parts in the transverse direction, i.e. transverse to the assembly direction or insertion direction. Oscillations and other stresses that occur during operation therefore do not lead to a loosening of the connection between the two housing parts. A secure connection in the insertion direction or assembly direction can also be achieved since only a tensile force between the housing parts needs to be produced, for example by means of an additional screw connection, in order to reliably secure the two housing parts to each other; no additional adjusting or stabilizing devices are required to ensure the desired assembly position of the two housing parts relative to each other. The final assembly position in the lateral and longitudinal directions is reached by inserting the projection into the receiving groove.

The improved stability is accompanied by a simplified assembly and the possibility of disassembly, for example for maintenance purposes. The housing parts are connected to each other by means of the connecting device and can be detached from each other again for maintenance purposes by detaching the connecting device. In addition, the splitting in two of the housing makes it possible to optimally adapt the structure of the respective housing part to the intended use, for example with regard to the selection of materials. It can be useful to embody the housing parts respectively in the form of a motor housing for accommodating the drive motor and a transmission housing for accommodating the tool shaft; the motor housing can be composed of a plastic and the transmission housing can be composed of a light metal such as aluminum. The connection by means of groove and projection can be implemented with no trouble even when the housing parts are composed of different materials.

For a particularly simple embodiment, it can be useful for one of the groove walls of the receiving groove to be constituted by the outer wall of the relevant housing part. This has the advantage that only the second groove wall delimiting the groove has to be embodied separately from the housing wall. For example, this occurs by means of this second groove wall being situated offset radially toward the inside and therefore toward the interior of the relevant housing part so that there are no components of the receiving groove protruding outward, achieving a smooth-surfaced outer wall. Only one separate groove wall has to be provided since the second groove wall is composed of the outer wall of the housing part.

One of the groove walls, in particular the groove wall situated radially toward the inside, is advantageously overlapped by a stabilizing section that is situated on the outer housing part, adjacent to the projection. This stabilizing section has a notch, which is adapted to the end surface of the groove wall, and the corresponding groove wall protrudes into this notch in the assembled position. The stabilizing section provides for an additional stability, particularly in the transverse direction.

To facilitate assembly, it can be advantageous for the outer wall of the housing part equipped with the receiving groove to be provided with a housing recess that is associated with a corresponding housing projection on the other housing part; in the assembled position, the housing projection protrudes into the housing recess. For example, this housing recess is embodied as semicircular and is advantageously situated in the assembly direction or insertion direction, in other words, it extends parallel to the projection that engages in the receiving groove.

One housing part is advantageously provided with a receiving cylinder whose function is to accommodate a connecting screw; the receiving cylinder is associated with a connecting opening on the outer housing part, through which the connecting screw is inserted. The receiving cylinder accommodates the threaded section of the connecting screw.

For example, the two housing parts to be connected are embodied in the form of a motor housing for accommodating a drive motor and a transmission housing for accommodating a tool shaft for driving the tool. In this embodiment, the receiving cylinder for accommodating the connecting screw is preferably provided on the plastic motor housing, which can preferably be manufactured using the plastic injection molding process. The light metal transmission housing, by contrast, does not require such a receiving cylinder, but only the receiving opening for the insertion of the connecting screw so that the light metal housing part to be manufactured using a casting process is embodied as simpler and requires less finishing work.

The plugged connection in the housing parts is advantageously provided offset radially relative to a through opening that accommodates a drive shaft of the drive motor. As a rule, two plugged connections are provided, which are each situated spaced radially apart from the through opening and are situated in the outer wall region of the housing parts. The plugged connections positioned on both sides ensure that the housing parts are axially aligned with each other in the desired position so that the drive shaft of the drive motor can be supported without play. The through opening between the housing parts advantageously functions as the seat of a bearing for supporting the drive shaft in rotary fashion.

Other advantages and suitable embodiments can be inferred from the remaining claims, the description of the figures, and the drawings themselves.

### DRAWINGS

FIG. 1 is a sectional depiction of a hand-held power tool embodied in the form of an angle grinder, having a motor housing for accommodating the drive motor and a transmission housing for accommodating the tool shaft,

FIG. 2 is a perspective detail view of the transmission housing with receiving grooves at the sides, each of which serves to accommodate a corresponding projection on the motor housing and is spaced radially apart from a through opening for the drive shaft of the drive motor,

FIG. 3 is a side view of the transmission housing,

FIG. 4 is a perspective depiction of the transmission housing and the section of the motor housing to be connected to the transmission housing,

FIG. 5 is a depiction corresponding to the one in FIG. 4, but from another perspective,

FIG. 6 is a perspective view of the transmission housing and motor housing in the assembled state,

FIG. 7 shows the transmission housing and motor housing from another perspective,

FIG. 8 shows the transmission housing and motor housing from yet another perspective,

FIG. 9 shows the hand-held power tool with the transmission housing and split motor housing.

In the drawings, parts that are the same have been labeled with the same reference numerals.

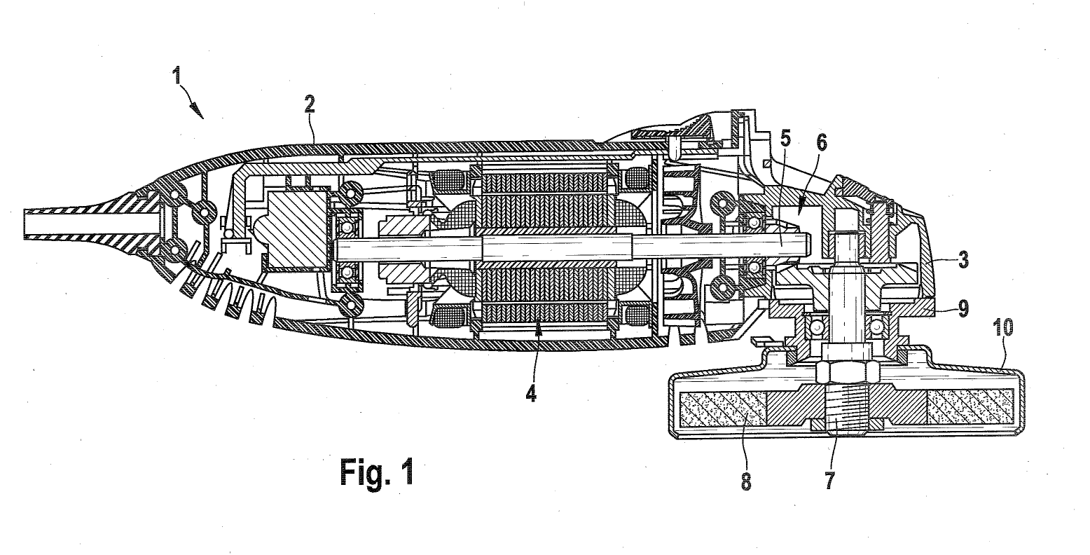

The hand-held grinding machine shown in FIG. 1 is an angle grinder with a two-part housing, comprising a motor housing 2 for accommodating an electric drive motor 4 and a transmission housing 3 for accommodating and supporting a tool shaft 7 that supports a tool 8; the tool shaft 7 is supported in rotary fashion in a bearing flange 9 in the transmission housing 3 and the tool 8 is encompassed by a wheel guard 10. The motor housing 2 is composed of plastic and is advantageously manufactured using the plastic injection molding process. The transmission housing 3 is preferably composed of light metal such as aluminum and is manufactured as a cast part. The transmission housing 3 accommodates a transmission 6 by means of which the rotary motion of an armature shaft or drive shaft 5 of the drive motor 4 is transmitted to the tool shaft 7.

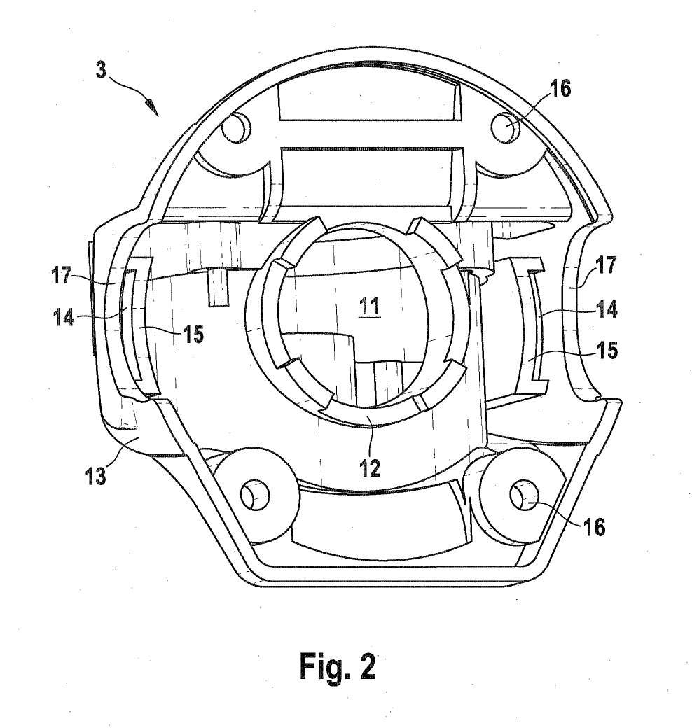

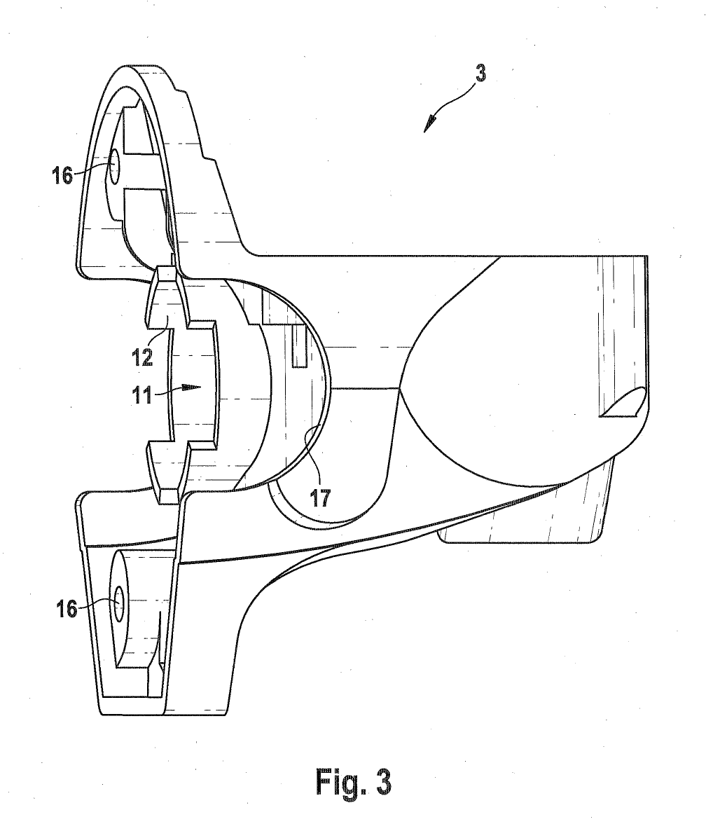

As shown by the detail views of the transmission housing 2 according to FIGS. 2 and 3, a passage neck 12 with a central through opening 11 for accommodating and supporting the armature shaft or drive shaft 5 of the drive motor is provided in the transmission housing, on the side oriented toward the motor housing. A bearing can be inserted into the through opening 11 in order to support the shaft 5 in rotary fashion.

A receiving groove 14 that extends in the axial direction of the through opening 11 is provided in each side wall region, spaced radially apart from the central through opening 11 and situated immediately adjacent to the outer wall 13 of the transmission housing 3.

The receiving groove 14 is part of a plugged connection by means of which the transmission housing is connected to the motor housing. In the assembled position, a projection on the motor housing is inserted into the receiving groove 14.

The receiving groove 14 is delimited by an inner groove wall 15 and an outer groove wall; the outer groove wall is identical to the outer wall 13 of the transmission housing 3. The receiving groove 14 and the inner groove wall 15 extend radially inward toward the interior of the housing.

The insertion direction into the receiving groove 14 is oriented in the axial direction of the through opening 11 that simultaneously constitutes the assembly direction in which the motor housing and the transmission housing are connected to each other. The longitudinal span of the receiving groove 14 extends perpendicularly to this.

A semicircular housing recess 17 that likewise extends in the assembly direction or insertion direction is provided in the outer wall 13 delimiting the receiving groove 14. The housing recess 17 serves to accommodate a corresponding housing projection on the other housing part 2. The receiving groove 14 is situated in the immediate vicinity of the housing recess 17.

To secure the connection between the transmission housing 3 and the motor housing 2, a plurality of outer connecting openings 16 distributed around the circumference are provided in the transmission housing 3, through which respective connecting screws can be inserted, whose threads are screw-connected to the motor housing.

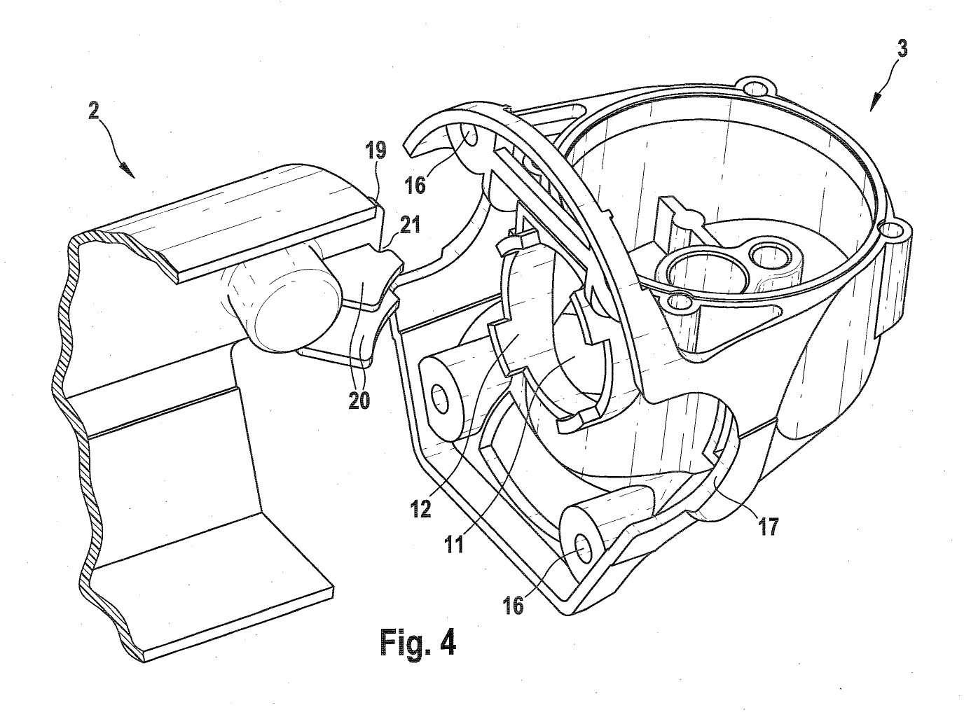

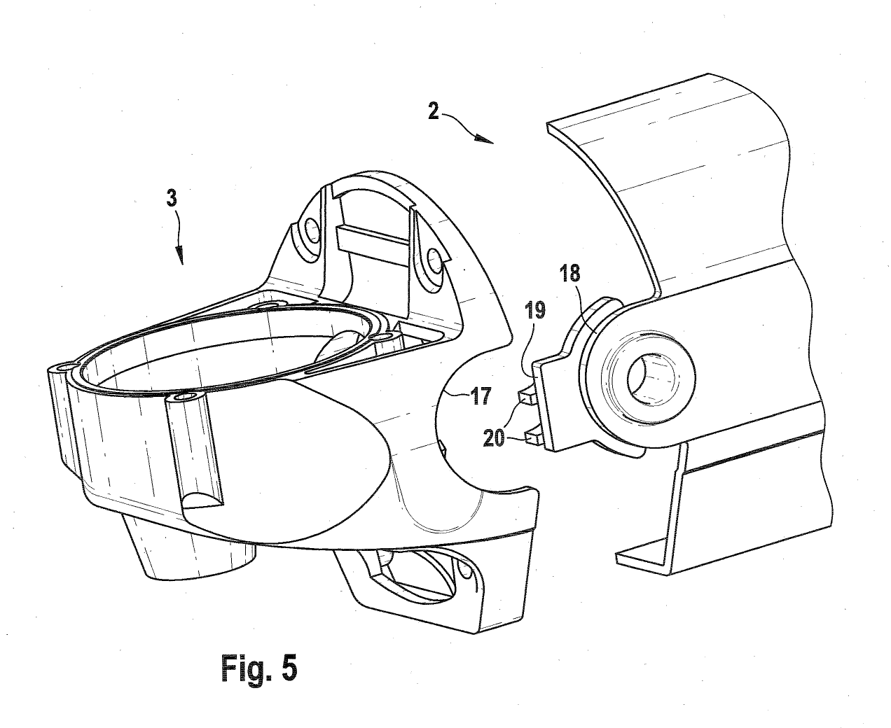

As shown in FIGS. 4 and 5, the motor housing 2 is provided with an axially protruding projection 19 whose wall thickness is attached to the groove width of the receiving groove in the transmission housing 3. In the assembled position, the end surface of the projection 19 protrudes into the receiving groove. The projection 19 is situated on a semicircular housing projection 18 that is associated with the likewise semicircular housing recess 17 in the transmission housing 3.

The projection 19 is provided with two stabilizing sections 20 that overlap the end surface of the inner groove wall 15 (FIG. 2), for which purpose a notch 21 is provided in the stabilizing sections 20. As a result, a stabilization of the connection between the motor housing and transmission housing is achieved, particularly in the transverse direction, i.e. transverse to the insertion direction or assembly direction.

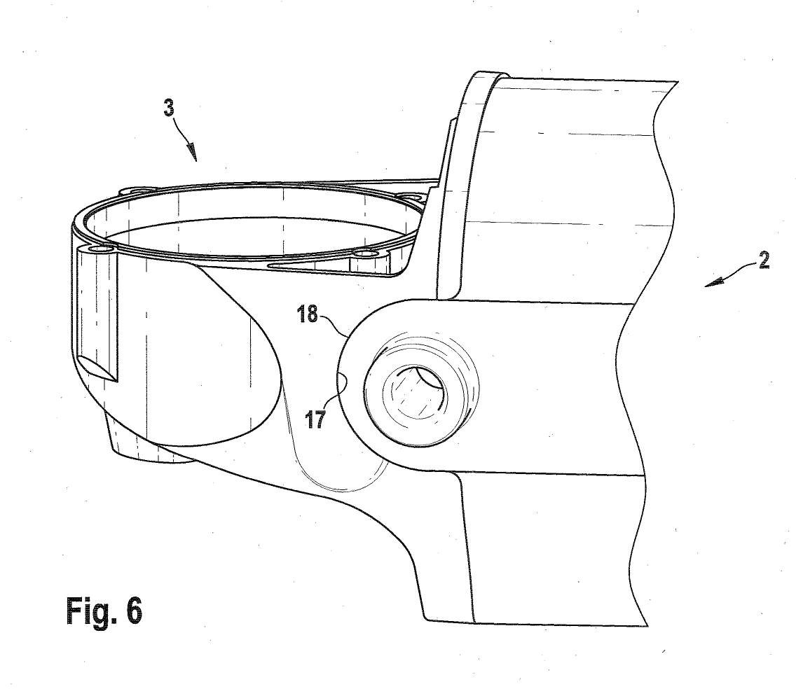

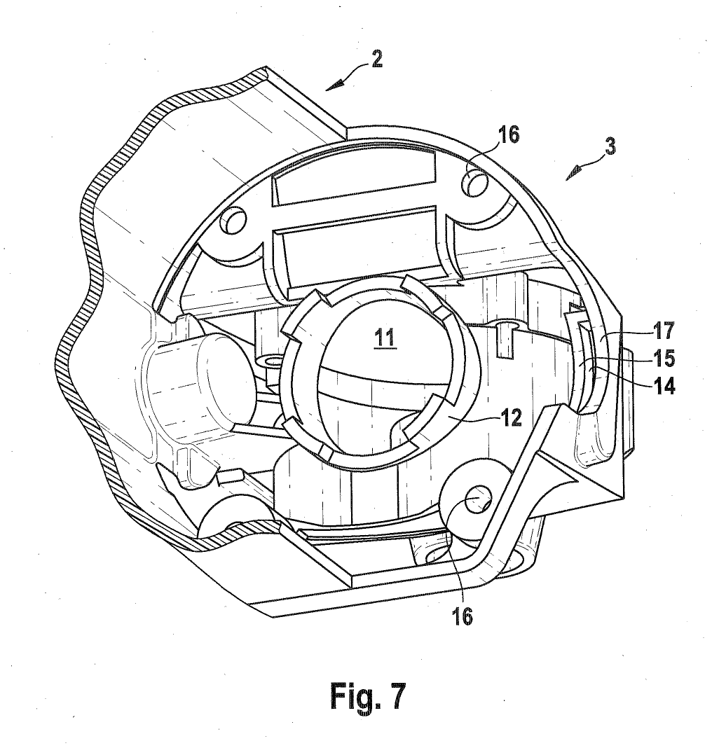

FIGS. 6 and 7 show the motor housing 2 and transmission housing 3 in the assembled position. The semicircular projection 18 rests in the complementarily shaped housing recess 17 and completely fills it. The projection protrudes into the receiving groove 14, which is situated immediately adjacent to the housing projection 18.

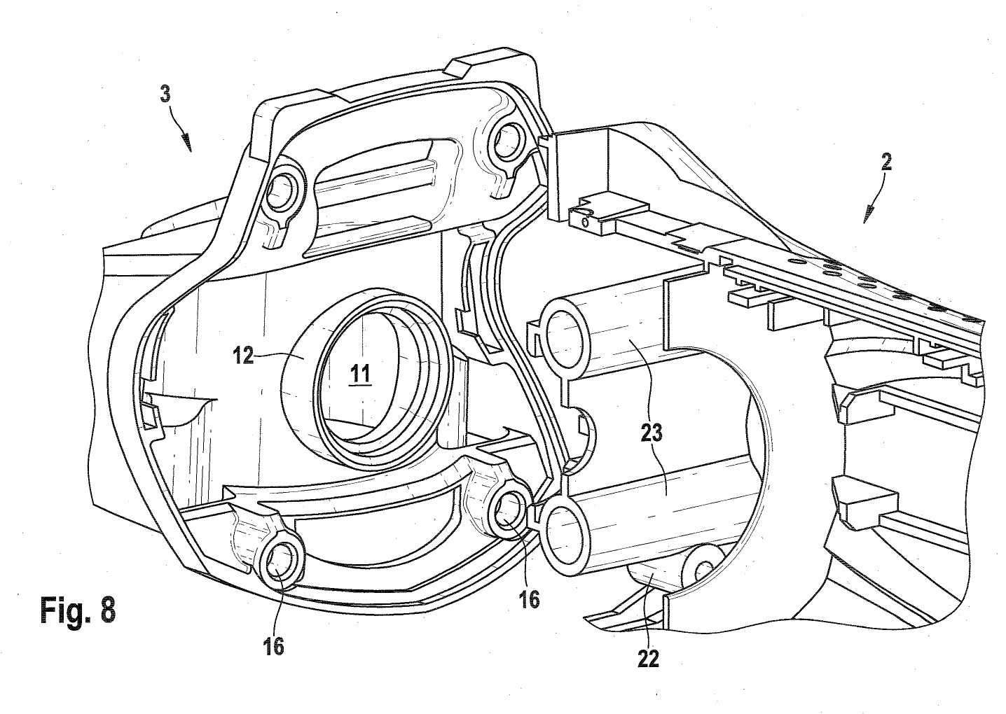

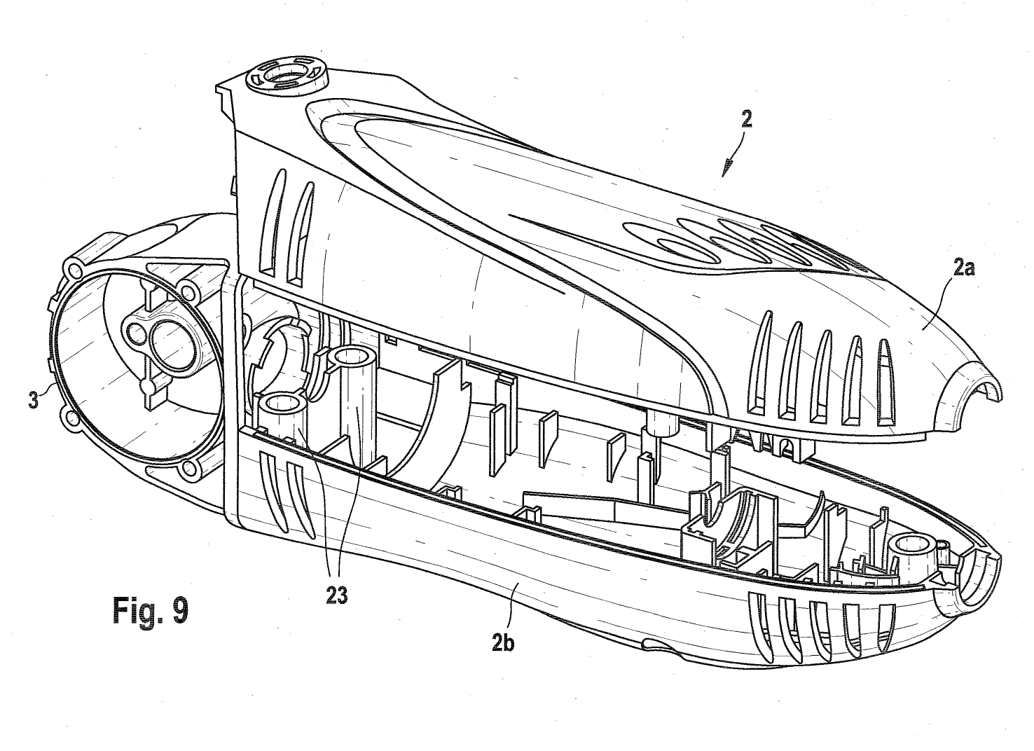

As shown in FIG. 8, one or more receiving cylinders 22 are embodied of one piece with the motor housing 2, are associated with the connecting openings 16, and serve to accommodate the threaded section of a connecting screw, which is inserted through the connecting opening 16. FIG. 8 also shows two essentially hollow, cylindrical transverse connecting sections 23 that are embodied of one piece with the motor housing and serve to connect two motor housing parts 2a and 2b shown in FIG. 9 of which the motor housing is composed. The transverse connecting sections 23 extend in the transverse direction, i.e. transverse to the axial direction or assembly direction, between the motor housing and transmission housing.

1-13. (canceled)

14. A hand-held power tool, in particular a hand-held grinding machine, comprising a housing of the hand-held power tool which includes two housing parts that are connected to each other by means of a connecting device, the connecting device having a plugged connection embodied by a receiving groove on one housing part of the two housing parts and a projection on an other housing part of the two housing parts that engages in the receiving groove in an assembled position, wherein groove walls which delimit the receiving groove extend in an assembly direction.

15. The hand-held power tool as recited in claim 14, wherein one of the groove walls is constituted by an outer wall of the housing part.

16. The hand-held power tool as recited in claim 14, wherein the receiving groove is situated on the inside of the outer wall of the housing part.

17. The hand-held power tool as recited in claim 15, wherein the receiving groove is situated on the inside of the outer wall of the housing part.

18. The hand-held power tool as recited in claim 14, wherein the outer wall of the housing part equipped with the receiving groove is provided with a housing recess and in the assembled position, a corresponding housing projection on the other housing part protrudes into the housing recess.

19. The hand-held power tool as recited in claim 15, wherein the outer wall of the housing part equipped with the receiving groove is provided with a housing recess and in the assembled position, a corresponding housing projection on the other housing part protrudes into the housing recess.

20. The hand-held power tool as recited in claim 16, wherein the outer wall of the housing part equipped with the receiving groove is provided with a housing recess and in the assembled position, a corresponding housing projection on the other housing part protrudes into the housing recess.

21. The hand-held power tool as recited in claim 17, wherein the outer wall of the housing part equipped with the receiving groove is provided with a housing recess and in the assembled position, a corresponding housing projection on the other housing part protrudes into the housing recess.

22. The hand-held power tool as recited in claim 18, wherein viewed in the assembly direction, the receiving groove immediately adjoins the housing recess.

23. The hand-held power tool as recited in claim 20, wherein viewed in the assembly direction, the receiving groove immediately adjoins the housing recess.

24. The hand-held power tool as recited in claim 21, wherein viewed in the assembly direction, the receiving groove immediately adjoins the housing recess.

25. The hand-held power tool as recited in claim 14, wherein a groove wall of the receiving groove is overlapped by a stabilizing section on the other housing part.

26. The hand-held power tool as recited in claim 26, wherein the stabilizing section is connected to the projection that engages in the receiving groove.

27. The hand-held power tool as recited in claim 14, wherein one housing part is provided with a receiving cylinder for accommodating a connecting screw; in the assembled position, the receiving cylinder corresponds with a connecting opening in the other housing part.

28. The hand-held power tool as recited in claim 14, wherein the housing parts comprise a motor housing for accommodating a drive motor and a transmission housing for accommodating a tool shaft.

29. The hand-held power tool as recited in claim 28, wherein the motor housing is produced out of plastic.

30. The hand-held power tool as recited in claim 28, wherein the transmission housing is produced out of light metal, in particular out of aluminum.

31. The hand-held power tool as recited in claim 29, wherein the transmission housing is produced out of light metal, in particular out of aluminum.

32. The hand-held power tool as recited in claim 14, wherein the plugged connection is situated offset radially relative to a through opening accommodating a drive shaft of the drive motor.

33. The hand-held power tool as recited in claim 14, wherein two plugged connections are provided on opposite sides of the housing.
